(19) United States
(12) Patent Application Publication
(10) Pub. No.: US 2018/0281125 A1
(43) Pub. Date: Oct. 4, 2018

(54) REPAIRING A PART HAVING CRACKS, AND PART

(71) Applicant: Siemens Aktiengesellschaft, München (DE)

(72) Inventor: Bernd BURBAUM, FALKENSEE (DE)

(21) Appl. No.: 15/762,611

(22) PCT Filed: Sep. 12, 2016
(86) PCT No.: PCT/EP2016/071394

§ 371 Date: Mar. 23, 2018

(30) Foreign Application Priority Data
Oct. 7, 2015 (DE) 10 2015 219 341.1

(51) Int. Cl. B23P 6/00; B23K 1/005; B23K 1/00; B23K 35/30; B23P 6/04; B23K 26/342; F01D 5/00

(52) U.S. Cl. CPC B23P 6/007; B23K 1/0056; B23K 1/0018; B23K 35/3033; B23K 2201/001; B23P 6/045; B23K 26/342; F01D 5/005; B23K 35/3046

(57) ABSTRACT

Components having cracks can be repaired more simply by the localized deposition of braze material onto a region that is to be repaired, and surrounding weld filler material. A method is disclosed for repairing a damaged component. The component has a substrate with cracks, wherein material is to be deposited at least in a region of a build-up region having the cracks. The method includes a braze material deposited at least in the region of the cracks and a weld filler material is deposited in the other regions of the build-up region, wherein the melting point of the braze material is at least 10K lower than that of the material of the substrate and the weld filler material, in which the braze material is always surrounded by a weld filler material in a plane, in particular completely surrounded.

### CROSS-REFERENCE TO RELATED APPLICATIONS

This application claims priority to PCT Application No. PCT/EP2016/071394, having a filing date of Sep. 12, 2016, based on German Application No. 10 2015 219 341.1, having a filing date of Oct. 7, 2015, the entire contents both of which are hereby incorporated by reference.

### FIELD OF TECHNOLOGY

The following relates to a method for repairing components, in which cracks in the component are closed during the repair, and to a component produced in this manner.

### BACKGROUND

The embodiment relates to repairing components using a weld filler material. Owing to a maximum possible removal depth of a side face of the component, not all components can be welded on the side faces. Prior to a welding process, the side faces of components are checked for cracks using FPI. The component is rejected if the FPI shows residual signs remaining at a maximum possible removal depth in the platform side face.

### SUMMARY

The following therefore has the advantage of solving the abovementioned problem.

A method is disclosed for repairing a damaged component. The component has a substrate with cracks, wherein material is to be deposited at least in a region of a build-up region having the cracks. The method includes a braze material deposited at least in the region of the cracks and a weld filler material is deposited in the other regions of the build-up region, wherein the melting point of the braze material is at least 10K lower than that of the material of the substrate and the weld filler material, in which the braze material is always surrounded by a weld filler material in a plane, in particular completely surrounded.

A component is disclosed comprising a braze material and a weld filler material are present in a build-up region, wherein the braze material is present at least in cracks, wherein the melting point of the braze material is at least 10K lower than that of the material of the substrate and/or the weld filler material, in which the braze material is always surrounded by a weld filler material in a plane.

### BRIEF DESCRIPTION

Some of the embodiments will be described in detail, with reference to the following figures, wherein like designations denote like members, wherein:

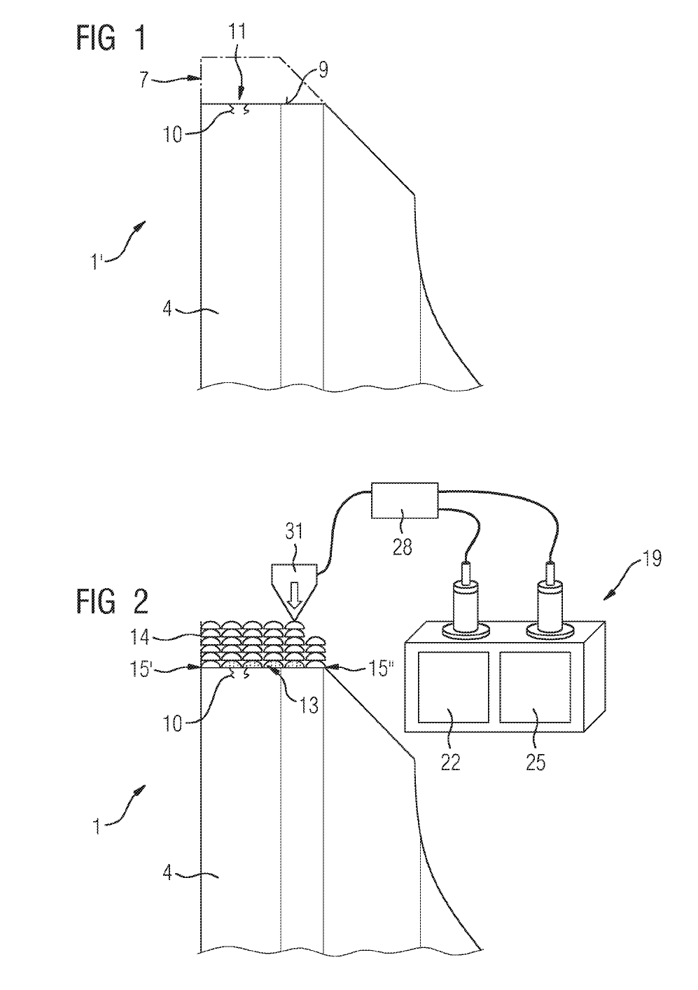

FIG. 1 shows a component that is to be repaired; and

FIG. 2 shows a partially repaired or complete repaired component, with the corresponding apparatus.

### DETAILED DESCRIPTION

The figures and the description represent only exemplary embodiments of the invention.

The figure shows a component 1′ that is to be repaired.

The component 1′ that is to be repaired has a substrate 4.

The substrate 4 is preferably metallic and in particular based on a nickel-based or cobalt-based superalloy, such as are used for high-temperature components such as turbine blades.

The substrate 4 has cracks 10 in a region 9 of a surface or point 11 that is to be repaired. Material is to be deposited over the cracks 10 and around the cracks 10 in order to form a build-up region 7 so that the component 1′ regains its original contour.

FIG. 2 shows a repaired component and an apparatus for repair.

The build-up region 7 is rebuilt by deposition welding.

The deposition welding is carried out preferably by laser deposition welding.

A braze material 25 is deposited locally in the region 9 of the cracks 10, in particular using the same deposition apparatus 31.

The melting point of the braze material 25 is at least 10K lower than that of the material of the substrate 4 and/or a weld filler material 22.

The weld filler material 22 matches or is similar to the material of the substrate 4, but can also be considerably different.

The braze material 25 is deposited broadly 13 only in the region 9 of the cracks 10, but does not reach the outer regions 15′, 15″ of the build-up region 7.

Preferably, only one layer of the braze material 25 is deposited.

The weld filler material 22 is deposited over the deposited braze material 25 and around the braze material 25.

The weld filler material 22 can match or be the same as or be similar to the material of the substrate 4′, but is different to the braze material 25.

The braze material 25 can have melting point depressors such as boron (B), silicon (Si) or elevated fractions of titanium (Ti), which also lower the melting point.

In the case of turbine blades made of a nickel-based or cobalt-based superalloy, the substrate and also the weld filler material 22 and the braze material 25 are nickel-based or cobalt-based and have the same or largely the same alloying constituents as the material of the substrate 4.

The repaired component 1 has a region 13 with braze material 25, which is also located in the cracks 10, which is completely surrounded by the substrate 4 and the deposition weld 14 consisting of the weld filler material 22.

Preferably, a final braze heat treatment is carried out.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1-9. (canceled)

10. A method
for repairing a damaged component,
wherein the component has a substrate with cracks,
wherein material is to be deposited
at least in a region of a build-up region
having the cracks,
said method comprising:
depositing a braze material at least in the region of the cracks and
depositing a weld filler material in the other regions of the build-up region,
wherein the melting point of the braze material is at least 10K lower than that of the material of the substrate and the weld filler material,
in which the braze material is always surrounded by a weld filler material in a plane, in particular completely surrounded.

11. A component,
comprising a braze material and a weld filler material are present in a build-up region,
wherein the braze material is present at least in cracks,
wherein the melting point of the braze material is at least 10K lower than that of the material of the substrate and/or the weld filler material,
in which the braze material is always surrounded by a weld filler material in a plane.

12. The method as claimed in claim 10, in which the material of the substrate, of the weld filler material and of the braze material are based on a nickel-based or cobalt-based superalloy.

13. The method as claimed in claim 10, in which only one layer of the braze material is deposited.

14. The method as claimed in claim 10, in which at least one layer of the weld filler material is deposited on top of the braze material.

15. The method as claimed in claim 10, in which the braze material is present only in the region having the cracks.

16. The method as claimed in claim 10, in which the braze material and the weld filler material are deposited using the same deposition apparatus.

17. The method as claimed in claim 10, in which a heat treatment is carried out.

18. The component as claimed in claim 11, in which the material of the substrate, of the weld filler material and of the braze material are based on a nickel-based or cobalt-based superalloy.

19. The component as claimed in claim 11, in which only one layer of the braze material is deposited.

20. The component as claimed in claim 11, in which at least one layer of the weld filler material is deposited on top of the braze material.

21. The component as claimed in claim 11, in which the braze material is present only in the region having the cracks.

22. The component as claimed in claim 11, in which the braze material and the weld filler material are deposited using the same deposition apparatus.

23. The component as claimed in claim 11, in which a heat treatment is carried out.
